(19) United States
(12) Patent Application Publication
(10) Pub. No.: US 2007/0065559 A1
(43) Pub. Date: Mar. 22, 2007

(54) Semi-finished food product and a process for preparing it

(76) Inventors: Renoo Avinash Blindt, Shambrook (GB); Bronwyn Elliott, Shambrook (GB)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 10/555,636

(22) PCT Filed: Dec. 16, 2003
(86) PCT No.: PCT/EP03/14517

§ 371 Date: Nov. 4, 2005

(30) Foreign Application Priority Data
May 27, 2003 (EP) 03253321.8
May 27, 2003 (EP) 03253320.0
May 27, 2003 (EP) 03253322.6

(51) Int. Cl. A23C 19/00

(52) U.S. Cl. 426/582

(57) ABSTRACT

A semi-finished food product is provided for preparing, terrins, mousses, cakes and the like. It comprises 30-60 wt % soft fresh cheese, 15-50 wt % cream and/or milk and 0.3-2 wt % polysaccharide gelling agent, and it is substantially free of egg yolk, gelatin and starch. It includes 2.5-9 wt % milk protein, 13-25 wt % fat, 65-85 wt % water and 0-5 wt % carbohydrate other than lactose. The semi-finished food product can be prepared by a process wherein, in a cheese-making factory, soft fresh cheese is mixed with at least part of the fluid ingredients to be included in the semi-finished food product, thereby providing a composition that retains a pumpable consistency at 5° C. for a period of at least 24 hours.

The present invention relates to a semi-finished food product. Both for the preparation of food products at home and in a commercial setting, there is a growing need of semi-finished food products with which high quality consumable end-products can easily be prepared. The standards that such semi-finished food products must meet are continuously raised. In particular there should be a low risk of failure, the time required to prepare the end product should be short and the resulting end product should have very good organoleptic properties. A further requirement which can be hard to reconcile with the other demands, is that the semi-finished food product should be versatile, i.e. a single semi-finished food product can be used for the preparation of a wide range of different consumable end-products. The present invention is concerned with a versatile semi-finished food product that can be used for preparing a wide range of high quality tarts, terrins, mousses, quiches, paté's and the like, quickly and easily.

U.S. Pat. No. 6,106,884 describes ready-to-bake cheesecake batter. The batter contains high amounts of sugar and corn syrup. The water content is relatively low. This has taste and texture consequences that deprive this product of versatility. The need to bake the product makes the preparation relatively time consuming.

EP 1,093,723 describes a method for preparing cheesecake. Cream cheese curd is blended with cream and/or non-fat dry milk to obtain a protein/fat ratio of 0.182-0.186. The batter is mixed with eggs, sugar, milk, flour and flavouring. The finished mix is baked for 60 minutes at 300-400° F. (149-204° C.).

U.S. Pat. No. 4,163,806 discloses a composition that is suitable for the preparation of a cheesecake that does not require baking and that is formulated from cream cheese, powdered sugar and non-dairy whipped topping.

WO 95/04468 describes dairy products including cream cheese filling, which are prepared by combining cream cheese with freezing point depressant, e.g. humectant such as alcohols and sugars. The water content of the dairy product is preferably 35-38%.

WO 96/24254 discloses dairy products that contain cream cheese, water binder, preserving agent and acidulant. The amount of water binder is most preferably 25-35 wt %. Examples of binders are sugars, gums, salts, starches, alcohols and mixtures thereof.

WO 02/37977 describes a creamy based processed dairy product containing gelatin. Ingredients include cream and cream cheese. The ingredients can be aerated to produce an overrun and then be intimately mixed with a hot, aqueous solution of gelatin.

WO 95/29595 describes dessert type food products that include cream, cream cheese, gelatin and sugar. First an aerated mixture is prepared. A hot gelatin solution is added while the much cooler mixture is beaten. The resulting product is allowed to set.

CA 2,011,526 describes dessert products that include cottage cheese, cream, milk, sugar and gelatin.

U.S. Pat. No. 4,312,891 describes dessert products that include soft fresh cheese such as cream cheese, cottage cheese curd or Neufchatel cheese and sucrose. The product has a reversible gel structure at refrigerator temperature. It includes gelatin and starch.

U.S. Pat. No. 5,250,316 describes an unbaked cheesecake that includes gelatin, gum, starch and ricotta cheese.

U.S. Pat. No. 4,425,369 discloses cheese containing compositions that can be used for e.g. cheesecake making. The composition contains cheese, a liquid, e.g. milk and/or water, and an emulsifier. Egg yolk may be used as emulsifier. Sugar can also be included. Cheesecake can for example be made using a recipe including whole egg and sugar, and baking the mixture for 50 minutes at 160° C.

U.S. Pat. No. 3,929,892, U.S. Pat. No. 4,244,983 and U.S. Pat. No. 4,724,152 describe low fat imitation cream cheese products. They contain a small amount of stabilizer e.g. carrageenan, guar gum and/or carob bean gum. The products have low fat contents and high protein contents.

None of the above publications discloses a satisfactory semi-finished food product that is versatile, easy to convert to the consumable end product in a short period of time and provides a high quality end product. The present invention offers an improvement in at least one of these aspects. The present invention provides a semi-finished food product that comprises

30-60 wt % soft fresh cheese,

15-50 wt % cream and/or milk, and

0.3-2 wt % polysaccharide gelling agent,

which food product is substantially free of egg yolk, gelatin and starch and which comprises

2.5-9 wt % milk protein

13-25 wt % fat

65-85 wt % water, and

0-5 wt % carbohydrate other than lactose.

The present invention also provides a process for preparing the semi-finished food product wherein, in a cheese-making factory, soft fresh cheese, preferably in a pumpable condition, is mixed with at least part of the fluid ingredients to be included in the semi-finished food product thereby providing a composition that retains a pumpable consistency at 5° C. for a period of at least 24 hours.

The present semi-finished product has a creamy, rich taste profile, yet it can be sufficiently neutral and subtle to be able to provide an excellent base for the preparation of both sweet and savoury flavoured end-products. These end-products can be mildly and subtly flavoured or have a strong, pronounced profile. This can be obtained by mixing taste-imparting substances, flavours and/or concentrates with the semi-finished product. For example, fresh fruit or fruit preservatives, chocolate flakes, vanilla etc can be used, optionally together with e.g. some sucrose for making sweet cake or pie fillings or e.g. desserts. Alternatively, bouillon, flaked Parmesan cheese, fish paste, pieces of vegetables and/or herbs and spices or other savoury materials can be included to make savoury pate's, terrins, quiches and the like.

By soft fresh cheese is meant cheese that is produced by acid coagulation with little or no added rennet and separation of “whey”. The acid may be provided by means of a culture or directly, e.g. by acidification with glucono-delta-lactone. By “whey” is meant a liquid that is separated off in the production of cheese. Traditionally, whey includes besides water, salt, lactose and/or lactic acid and other small molecules, also whey proteins. In the present context, “whey” includes the liquid or “permeate” that is separated in modern cheese-making processing using ultra filtration. In such processes, the ultra filtration membrane usually retains the whey protein in the retentrate. Accordingly, the liquid or “whey” separated off in such cheese-making processes usually does not contain whey protein. Typically, the soft fresh cheese will not have been cured. The fat content of the cheese is not critical. Combinations of soft fresh cheeses may be used. For example the cheese may comprise a combination of cottage cheese and cream cheese, or of quark, Neufchatel and cream cheese. Preferably, overall the soft fresh cheese has a fat content 18-40 wt %, more preferably of 22-35 wt %. Although low or no fat cheese such as quark or cottage cheese may be included in the present product, any cheese used as soft fresh cheese in the present product preferably has a fat content of 18-40 wt %, more preferably of 22-35 wt %.

The semi-finished food product should comprise 15-50 wt % of cream or milk or a combination thereof. The milk may for example be whole milk or partially or wholly skimmed milk. The milk may be partially or wholly reconstituted milk. Part or all of the milk fat may have been replaced by oil or fat of vegetable origin. The cream may be dairy cream or part or all of the fat of the cream may have been replaced by oil or fat of vegetable origin. The fat content of the cream is not critical. It can suitably be chosen in the range of 5-65 wt %. Usually it will be chosen in the range of 10-50 wt %. The amount of cream, if any, and its fat content can be adapted to obtain the desired fat content in the semi-finished food product.

If so desired, water may be incorporated in the product. Preferably however, the amount of water included does not exceed 40 wt % of the semi-finished product. More preferably it does not exceed 35 wt % of the semi-finished product.

The components included in the semi-finished food product should be such that the product has a fat content of 13-25 wt %, preferably 14-20 wt %.

The semi-finished food product should have a milk protein content of 2.5-9 wt %, preferably 3-7 wt %. Part of the milk protein will be provided by the milk and/or the cream. Their milk protein contents will usually be in the range of 1-5 wt %, preferably 2-4 wt %. The cheese is preferably chosen such that its milk protein content is in the range of 4-25 wt %, more preferably 5-18 wt %, especially 6-15 wt %. The sources of milk protein are preferably chosen such that the milk protein in the product consists of 2-35 wt % whey protein and 65-98 wt % casein.

The semi-finished food product may include some carbohydrate other than lactose, but this should not amount to more than 5 wt %. Some carbohydrates will be contained in the cheese, milk and/or cream and the gelling agent. Preferably no component is deliberately included in the product that is rich in carbohydrate other than lactose. It is especially preferred not to include sucrose or corn syrup or the like. Furthermore, starch should preferably not be deliberately included. Such carbohydrate sources other than the dairy components and the gelling agent may adversely affect the versatility of the product and/or its texture and mouthfeel.

For an optimal product the combined amount of fat and water is suitably chosen to be 80-96 wt % of the product, preferably 85-95 wt %. The pH of the semi-finished product is preferably 4.2-5.2, more preferably 4.3-4.9. The pH of the cheese employed can suitably be chosen in the range of e.g. 4.2-5.1. Especially at the lower end of this range this may be sufficient to get the desired pH in the semi-finished food product. If so desired, food acid may be included to adjust the pH. For example citric acid may be included in the semi-finished food product.

The semi-finished food product should be substantially free of egg yolk, of gelatin and of starch. For each of these materials, by “substantially free of” is meant that the material if present at all, is only present at such a low amount that a typical consumer can not tell the difference compared with the same product that does not contain that material. In such comparison, the two products should be offered to the consumer sequentially with a wash-out period of 1 hour in between. Preferably the semi-finished food product does not contain egg yolk at all. It is also preferred that it does not contain gelatin at all. It is furthermore preferred that it does not contain starch at all. Each of these materials if present, may increase the risk of failure in the preparation of the consumable end product. They may adversely affect the versatility of the semi-finished food product, e.g. by the influence on the texture and/or the taste, but also for product safety or religious reasons. Furthermore, the interaction of anyone of these materials with the polysaccheride gelling agent may adversely affect the structure of the semi-finished food product or of the consumable end-product. Such mixed biopolymer systems may suffer from a variety of defects. Phase separation may occur and syneresis problems may arise. The materials may also cause an undesired change in the structure of the semi-finished food product during storage. Accordingly, the presence of egg yolk, gelatin and starch is preferably avoided completely.

The semi-finished food product should include 0.3-2 wt % polysaccharide gelling agent. This gelling agent should not consist of starch. Preferably the gelling agent is a thermo-reversible gelling agent, i.e. the gel can be caused to melt or to set by raising or lowering the temperature, respectively. Preferably the gelling agent is selected from the group consisting of agar, gellan, agarose, furcelleran, kappa carrageenan, iota carrageenan, a combination of xanthan gum and locust bean gum, a combination of xanthan gum and konjac flour and combinations of two or more thereof. Most preferably the gelling agent is agar. For optimal texture, versatility and mouthfeel, it is preferred that the semi-finished food product does not contain non-gelling, thickening hydrocolloids. For example the product should preferably not contain guar gum. Most preferably the product contains agar and no other polysaccharide hydrocolloid.

The semi-finished food product can suitably be prepared by blending all components together and optionally pasteurising the mixture and packing it. In a specific embodiment of the present invention the semi-finished food product is packed in two containers, such that a first container contains a first part of a composition that constitutes the semi-finished food product and a second container contains a second part of the composition that constitutes the semi-finished food product, the second part being complementary to the first part. By “complementary” is meant here that the composition that is formed by taking the first part and the second part together, meets the requirements described above for the semi-finished food product. For example, all components of the product except the gelling agent can be combined and this combination can be packed in one container while a corresponding amount of gelling agent, e.g. in powder form, is packed in another container. The two packs can then be supplied in combination. At the point of use, the gelling agent can be incorporated in the dairy base composition, optionally after wetting, swelling or dissolving it in a small amount of liquid, e.g. milk or water. Such an approach may for example be beneficial if it is desired to use a gelling agent that is set by cations.

If the semi-finished food product is packed in two containers then preferably the gelling agent is contained in the first container. The gelling agent may for example be a powder that is packed in a sachet. Alternatively, the gelling agent may have been dispersed in a liquid and have been allowed to set e.g. as a gelled block. For this, part of the water or milk of the semi-finished food product may be used. The soft fresh cheese is preferably included in the second container. In a further preferred embodiment, any cream included in the composition that constitutes the semi-finished food product is preferably included in the container that contains the soft fresh cheese.

In another, preferred embodiment all components jointly making up the semi-finished food product are combined, the gelling agent is a thermo-reversible gelling agent and the semi-finished food product is sheared during cooling such that the product remains fluid even though the gel has set. For the preparation of the consumable end product, the composition can be caused to set as a gelled layer or block by heating it and allowing it to cool down again under quiescent conditions. The semi-finished food product prepared in this manner is a so-called sheared gel.

Sheared gels, also referred to as microgels, have been described in the literature. EP 355 908 describes preparations constituting thermo-reversible sheared gels and their preparation. The resulting product is a fluid which can be stored indefinitely in its mobile state but which can be returned to its normal more rigid state by heating through the transition temperature of said composition, whereafter the heated solution will form a normal gel on cooling under quiescent conditions. EP 432 835 describes sheared gel preparations that are chemically set.

Irrespective of whether the gelling agent and possibly some liquid is provided packed separately from the balance of the composition or whether it is combined therewith, the composition may be a so-called pre-mix that has been obtained by cold mixing all the components except possibly the gelling agent and some liquid. Alternatively, it may be a pasteurised, and optionally homogenised, composition, which may subsequently have been cooled down with or without the application of shear. Thus the composition may be a gelled block or a sheared gel. This may be the case even if the gelling agent is packed separately, because the milk proteins originating from the cheese have gelling properties as a result of the cheese making process. If the gelling agent is provided in a separate container, it may be provided for example as a powder, or as a concentrated block or sheared gel of the gelling agent in water or another liquid, e.g. skimmed milk.

Preferably, however, the gelling agent is intimately mixed with the other components of the product such that a single mixture constitutes the semi-finished product. In this embodiment, as described above, the semi-finished product may, for example, be a pre-mix, a gelled block or a sheared gel. In an embodiment of the invention, the semi-finished food product may have a “borderline” structure, e.g. be a weakly gelled block. This may for example be achieved by using a relatively low amount of gelling agent. Alternatively, in a preferred embodiment, it may be achieved by heating the composition and subsequently applying shear during the initial cooling stage but not during the entire cooling stage. E.g. shear could be applied until the temperature has been reduced to 25° C. while further cooling is caused to occur under quiescent conditions. The resulting product has macroscopically a weakly gelled block structure with internally a sheared gel type structure. Such a product can be attractive for ease of application, a pleasant appearance and/or good organoleptic properties.

The customer wishing to prepare the end product can do so by stirring into the semi-finished product any components he or she wishes to incorporate and allowing the composition to set, possibly after filling it into a pastry base or other mould. However, preferably the end product is prepared by heating the composition to a temperature of e.g. about 80° C., mixing in any additional components desired before or after the heating and allowing the composition to set under quiescent conditions in a mould to obtain the consumable end product.

To prepare the semi-finished food product, soft fresh cheese needs to be combined with cream and/or milk. To do this at large scale raises the question how to handle the soft fresh cheese. Typically such cheese is solid and not pumpable. It is available in buckets, e.g. in 5 or 10 kg amounts. Making the semi-finished food product starting from such solid soft fresh cheese in large volume would be costly and labour intensive. We have found a solution to this problem.

Preferably the semi-finished food product is prepared with a process that includes the step of mixing soft fresh cheese in a cheese-making factory with at least part of the fluid ingredients to be included in the semi-finished food product. We surprisingly found that if soft fresh cheese is mixed with part or all of e.g. the milk, cream and/or the water, a pre-mix is obtained that even at a temperature of 5° C. will stay pumpable for an extended period of time. The process is particularly beneficial if the soft fresh cheese is still in pumpable condition. Accordingly, preferably, soft fresh cheese that is in pumpable condition is mixed with part or all of the fluid ingredients.

Mixing should be applied until the mixture is smooth. We found that once a smooth, fluid consistency is obtained, the composition will retain its pumpability over an extended period of time. For this the amount of fluid ingredients mixed in is not critical. If a composition looses its pumpability, this can be resolved by mixing somewhat longer, or by raising the temperature of the composition and cooling it again while mixing. Although it is not normally necessary to increase the liquid amount mixed into the composition to obtain a pre-mix that will stay pumpable for an extended period of time, if so desired, such a pre-mix may be obtained with a shorter mixing timing if more liquid is included. However, mixing should be continued until the composition has reached a homogeneous consistency, and once this state has been reached, the composition will usually stay pumpable. This effect may be achieved even if only very little liquid is included and/or if soft fresh cheese is used that has already solidified to a solid material, i.e. that is no longer pumpable. In such case the required mixing time may be somewhat longer. Preferably the soft fresh cheese does not contain structuring hydrocolloids such as for example locust bean gum or guar gum.

Preferably, at least 50 wt %, more preferably at least 75 wt % of the fluid ingredients to be incorporated in the semi-finished food product are cold mixed with the pumpable soft fresh cheese in the cheese-making factory. Other ingredients e.g. acid and/or preservative may be included as well. The composition may optionally be pasteurised and/or homogenised. The soft fresh cheese included in the composition to be mixed, will usually have a temperature of 40-50° C. or of about 20° C., depending on the cheese-making process applied in the factory. After or during the mixing the temperature is preferably reduced to about 10° C. or less, especially to about 5° C. or less. The composition obtained may be packed e.g. in pots or cartons. Preferably, however, the composition is transferred in bulk to another location at which the composition is combined with the balance of the composition that is to constitute the semi-finished food product, and optionally, the semi-finished food product is packed in containers.

For example, the other location may be a processing and packing line in a different part of the cheese-making factory or in a different factory on a remote site. The transfer in bulk can for example be by pumping through a pipe if the distance is short. Alternatively it can be done by chilled transport in a tank wagon or in Pallacons®, which are containers for bulk shipment of e.g. 0.5 or 1 tonne quantities. Any ingredients still to be included for the semi-finished food product, if any, can be included. Preferably, the gelling agent, optionally after hydrating it in some liquid, is included at this stage. The composition may optionally be pasteurised and/or homogenised. Preferably the composition is processed to turn it into a sheared gel. The composition can then be packed. Packing is preferably done aseptically. The semi-finished food product may be packed in complementary containers as described above. For example, the gelling agent, optionally in hydrated form as a block or sheared gel, can be packed in one container with the balance of the composition in the complementary container. However, preferably the entire composition constituting the semi-finished food product is packed as a complete admixture, e.g. in pots or cartons of e.g. 0.5 or 1 liter.

Alternatively, the other location may be the site of an industrial manufacturer of cakes, mousses, quiches, terrines, pies and/or pastries and the like. Any ingredients still to be included to obtain the semi-finished food product, if any, can be included at this location, and the manufacturer can use the semi-finished product for the production of the end product without intermediate packing. For example the semi-finished food product can be heated in bulk e.g. to 80° C., be combined with flavourings or other ingredients such as strawberries or salmon, before or after the heating. The mixture can then be filled into moulds, e.g. a biscuit base, pastry base or plastic container, and be allowed to set to obtain the consumable end-product.

Throughout this specification all parts, percentages and ratios are by weight unless otherwise indicated. Except with respect to the preparation of the consumable end products described in the examples, all parts, percentages and ratios relate to the weight of the semi-finished food product, unless specifically indicated otherwise. Except in the operating and comparative examples, or where otherwise explicitly indicated, all numbers in this description indicating amounts of material ought to be understood as modified by the word “about”.

The term “comprising” is meant not to be limiting to any subsequently stated elements but rather to encompass non-specified elements of major or minor functional importance. In other words the listed steps, elements or options need not be exhaustive. Whenever the words “including” or “having” are used, these terms are meant to be equivalent to “comprising” as defined above.

### EXAMPLE 1

A professional chef prepared mini coffee cheesecakes using his usual recipe and preparation method as follows.

Biscuit base mix was heated on a stove for 5 minutes. Base was then placed into 8 small moulds.

Recipe for the gelled part of 8 mini cheesecakes:

15 g gelatine

2 teaspoons liquid coffee concentrate

150 g soft brown sugar

450 g Philadelphia® cream cheese

300 ml whipping cream

300 ml water

The sugar and part of the water were put into a pan. The gelatine powder was sprinkled over the cold water and stirred in. The mixture was boiled and the remainder of the water was brought to the boil and added as well. This was stirred continuously. It took 11 minutes to dissolve the gelatine. This mixture was set aside and left to cool down for a few minutes.

The cream cheese and coffee concentrate were put in a food processor and mixed briefly. It was then transferred to a bowl. The cream was whipped in a Kenwood™ mixer. The gelatine mixture was mixed into the cream cheese mix. Then the whipped cream was folded into the mixture. The resulting composition was poured onto the biscuit base in the moulds. The products were put in a refrigerator to set.

The total preparation time was 30 minutes. The minimum setting time to obtain products that could reasonably be consumed was 1 hour and 45 minutes. The chef commented that he usually left the product overnight to be sure that it had sufficiently set at the time of consumption.

The following composition was used for the preparation of a semi-finished food product:

54 parts by weight (pbw) Philadelphia® cream cheese ex Kraft Foods, UK

1 pbw agar

19 pbw Elmlea® single (a cream ex Van den Bergh Foods Ltd UK consisting of a blend of buttermilk and vegetable oils. The fat content was 13%)

26 pbw water

The semi-finished food product was prepared as follows. The cream and water were put in a beaker and mixed. The agar was cold dispersed in the mixture and stirred for about 5 minutes. The mixture and the cream cheese were put in a jacketed vessel provided with a stirrer and connected to a hot water supply. The lid was closed. The stirrer was operated at low speed and the heating was turned on. The temperature was raised to 90° C. and the stirrer speed was increased to 350 rpm. Then the jacket of the vessel was connected to a cold water supply. Stirring was continued until the temperature of the composition had reduced to 15° C. The composition was then poured into sterile plastic bottles of 500 ml. The lid was screwed on and the bottles were stored in a refrigerator until further use.

The semi-finished food product was a sheared gel and it contained 4 wt % dairy protein. The mono- and disaccharide content was 3 wt %. Most of this was lactose. The fat content was 15 wt %. The water content was 76 wt %. The combined amount of water and fat present in the sheared gel was 91 wt %. The pH was 5.0. After several days storage the sheared gel was still mobile. It had a viscous, easily spoonable consistency.

The sheared gel was used to make a coffee cheesecake with the following recipe:

500 g sheared gel

50 g soft brown sugar

2 teaspoons coffee concentrate

Moulds with biscuit base mix were prepared as described above. The sugar, coffee concentrate and sheared gel were put in a ceramic bowl and briefly mixed. The mixture was heated in a microwave at 650 watt for 5 minutes. It was briefly stirred two times during the heating. After 5 minutes the composition had reached a temperature of 81° C. It was briefly whisked with a hand whisk. The mix was poured onto the biscuit base in the moulds and the cheesecakes were put in a refrigerator. The preparation time had been only 8 minutes. After 10 minutes in the refrigerator the gel had set and the cheesecakes were ready for consumption.

The chef judged the cheesecakes prepared from the sheared gel to have very good texture, taste and flavor. They were as good as the cheesecakes prepared with his traditional recipe. The preparation time, setting time, amount of work and the number of utensils used and to be cleaned afterwards were all markedly lower for the recipe based on the semi-finished product.

### EXAMPLE 2

A semi-finished food product was prepared from the following composition:

54 pbw “American style full fat soft cheese” ex Yoplait, UK.

(This is a cream cheese alternative, suitable for vegetarians).

0.5 pbw agar

19 pbw of a low fat dairy cream alternative consisting of a blend of skimmed milk and vegetable fat. The fat content was 10%)

25 pbw water

1 pbw K-sorbate solution (10% solution)

0.11 pbw citric acid.

The product was prepared as follows. The cream and the cream cheese alternative were placed in a mixer with the water, sorbate and citric acid. The mixer was turned on. The agar was dispersed into the mixture. The resulting mixture was fed into a scraped surface heat exchanger (SSHE) and pre-heated to 85° C. From here the product was fed into a single stage homogeniser at 500 psi. Next it was pasteurized in another SSHE at 110° C. for 12 sec. The flow rate of the process was 120 l/hr. The product was cooled with water to 45° C. in a SSHE and then to 14° C. by a glycol cooled SSHE. It was stored in a sealed sterile tank before being aseptically packed using a Metal box SL1 aseptic pot filler. The product was filled into 150 ml plastic pots sealed with a foil lid and stamped with the product name and the date of manufacture.

The product contained 3 wt % milk protein, 4 wt % carbohydrate most of which was lactose, 17 wt % fat and 74 wt % water. The pH was 4.5.

A leaflet was prepared with Product Handling Guidelines for the users. The user was instructed to heat the product to a minimum of 75° C. for one minute, to activate the setting process. Ingredients could be added before or after the heating process. For cold serve products it was recommended to chill for 15 minutes before serving. Hot serve products would also set in 15 minutes and could be hot-held.

### EXAMPLE 3

A smoked fish based gelled product was prepared from the following recipe.

250 g QimiQ® (QimiQ contains 1 wt % gelatin and otherwise only contains dairy cream and skimmed milk. QimiQ® was obtained from Hama Foodservice, Austria.)

125 g smoked mackerel

125 g dairy cream

½ teaspoon of finely chopped dill tips

lemon juice

white pepper

salt

mustard

The QimiQ was whisked till smooth. The smoked fish was finely chopped and added together with the seasoning and dill tips. The cream was whipped and folded into the mixture. The mixture was then filled into a mould and put in the refrigerator. The preparation time was 10 minutes (excluding cutting the fish and the dill tips).

A similar product was made using the semi-finished food product described in example 1. In the recipe 375 g of the semi-finished product was used instead of the QimiQ and the cream. The semi-finished product did not need to be whisked. After all components had been combined in a bowl, the bowl was put in a microwave and heated for 3 minutes at full capacity. The temperature reached was 72° C. The composition was then poured in the mould and placed in the refrigerator. The preparation time was 5 minutes (excluding cutting the fish and the dill tips).

After the products had been allowed to set for 60 minutes, they were removed from the refrigerator. The product based on the semi-finished product had fully set. It could easily be de-moulded and it retained the shape of the mould. It could be cut and its texture was smooth and creamy.

The product prepared with QimiQ had not yet set and could not be de-moulded. The volume of product obtained from the same weight of recipe was less, suggesting that it had retained less air during the preparation.

### EXAMPLE 4

A chocolate based gelled product was prepared from the following recipe:

560 g semi-finished food product as described in example 1

100 g chocolate chips

3 dessert spoons crystal sugar

1 teaspoon rum

The components were combined, briefly mixed and heated in a microwave at full power for 5 minutes. The composition reached a temperature of 80° C. The chocolate chips had molten. The composition was then briefly mixed through and poured into 4 small moulds and put in the refrigerator for 60 minutes. After 20 minutes in the refrigerator the product was already fully set. It could be easily de-moulded and it retained the shape of the container. It could be cut and its texture was smooth and creamy.

### EXAMPLE 5

Trials were done using different types and amounts of gelling agent and salt.

Sheared Gel Compositions

53.7 pbw full fat soft cheese (28% fat) as described in example 2

18.8 pbw Elmlea® single (see example 1)

25.82 pbw water

0.01 pbw citric acid

0.1 pbw K-sorbate (10% solution)

gelling agent
salt

The type and amount of gelling agent and salt were as follows

Ex 5a: 0.5 pbw Kappa carrageenan

0.3 pbw NaCl (10% solution in water)
   Ex 5b: 0.6 pbw iota carrageenan
0.5 pbw CaCl₂.2H₂O (10% solution)
   Ex 5c: 0.6 pbw gellan
0.5 pbw CaCl₂.2H₂O (10% solution)×
   Ex 5d: 0.6 pbw Kappa carrageenan with 25% furcelleran
0.6 pbw CaCl₂.2H₂O (10% solution)
   Sheared Gel Preparation:

The K-sorbate, water, Elmlea® and citric acid were placed in a jacketed heating vessel. The gelling agent was added slowly with stirring and stirring was continued for 5 minutes. The soft cheese was added and the mix heated to 50° C. Then the salt was added. The mixture was heated to 90° C., kept at that temperature for 10 minutes and then cooled down over 2 hours to below 15° C. Stirring was continued through the whole preparation. The sheared gel was stored at 5° C.

Preparation of Raspberry Mousse:

125 g of the sheared gel was heated in a microwave oven to 80° C. After the heating 20 g raspberry puree and 15 g sugar were stirred in. The mixture was poured in a small bowl and placed in a refrigerator at 5° C. to allow it to set.

The sheared gels obtained were relatively thick. The raspberry mousse was somewhat salty. Overall, the sheared gels were not as convenient to use as the sheared gel based on agar. The taste and texture of the gelled food products obtained were not as good as those obtained with sheared gel based on agar.

### EXAMPLE 6 (COMPARATIVE)

The following composition was used to prepare a sheared gel

| | |
|---|---|
| 53.7 pbw | full fat soft cheese (28% fat) as described in example 2 |
| 44.6 pbw | water |
| 0.5 pbw | agar |
| 0.1 pbw | citric acid |
| 0.1 pbw | K-sorbate (10% solution) |

The sheared gel was prepared as described in example 5, mutatis mutandis.

The sheared gel obtained was used to prepare raspberry mousse, as described in example 5.

The taste and texture of the resulting product was not very good. The mouthfeel was a bit rubbery and cracks appeared in the set product.

### EXAMPLE 7

A series of trials were done with 2 different types of soft fresh cheese. Their composition was as follows

| soft fresh cheese | | |
|---|---|---|
| composition (wt %) | Milklink ®* | Blackmore Vale ®** |
| water | 54 | 60 |
| fat | 31 | 31 |
| protein | 6.4 | 8.6 |
| carbohydrate | 6.0 | trace |

*Milklink ® full fat soft cheese, a soft fresh cheese, is available from Milklink Ltd, Staplemead Creamery, Frome, Somerset UK
**Blackmore Vale ® American style full fat soft cheese, a soft fresh cheese, is available from Blackmore Vale Farm Cheese Ltd, Shaftesbury, Dorset, UK.

Sheared gels were prepared using the following recipes, expressed in pbw

| | Example | | | | |
|---|---|---|---|---|---|
| | 7A | 7B | 7C | 7D | 7E |
| Milklink ® | 51 | 51 | 48 | 54 | — |
| Blackmore Vale ® | — | — | — | — | 51 |
| Skimmed milk | 18.9 | 18.9 | 18.9 | 18.9 | 18.9 |
| Dairy cream (48% fat) | — | 2.44 | — | — | 2.44 |
| Water | 29.5 | 27.05 | 32.5 | 26.5 | 27.05 |
| Agar | 0.5 | 0.5 | 0.5 | 0.5 | 0.5 |
| Citric acid | 0.085 | 0.11 | 0.085 | 0.09 | 0.14 |

The sheared gels were prepared as described in example 5, mutatis mutandis. All products obtained had good consistency. They were convenient to use. Their composition was as follows (expressed as wt %)

| | Example | | | | |
|---|---|---|---|---|---|
| | 7A | 7B | 7C | 7D | 7E |
| Water | 74 | 73 | 76 | 73 | 76 |
| Protein | 3.9 | 3.9 | 3.7 | 4.1 | 5.0 |
| Fat | 16 | 17 | 15 | 17 | 17 |
| Carbohydrate | 4.5 | 4.5 | 4.3 | 4.6 | 1.5 |

These sheared gels can suitably be used to prepare gelled food products, for example raspberry mousse, using the recipe and preparation method described in example 5.

### EXAMPLE 8

Milklink® soft fresh cheese as described in example 7 was used.

The recipe for the semi finished food product was

| | | |
|---|---|---|
| 54 | pbw | Milklink ® soft fresh cheese |
| 4.1 | pbw | homogenised double cream (48% fat) |
| 41 | pbw | skim milk |
| 0.5 | pbw | powdered agar |
| 0.21 | pbw | citric acid |
| 0.1 | pbw | potassium sorbate |

In a cheese-making factory the cheese was taken from the production line in pumpable condition, cooled to a temperature of 6-13° C. and fed to a mixing tank fitted with an agitator, Silveston mixer and recirculation loop. The other ingredients were also fed to the mixing tank. The mixture was blended until it was smooth and liquid. The final temperature was 6° C. The premix obtained was packed into a 1 tonne Pallacon® and blast chilled to 4° C. The mixture was then transported refrigerated to a processing facility where it was pumped into a mixing tank and mixed for 5 minutes. It was then sterilised by passage through a UHT heat exchanger, cooled under shear to below 20° C. and then packed aseptically into cartons.

Alternatively, the composition can be cooled to 4° C. by passage through a plate heat exchanger before transferring it into the Pallacon®.

As a further alternative the premix can be prepared without including the agar and while keeping back a small amount liquid, e.g. skim milk. The agar can be hydrated at the processing facility and mixed into the premix there, before packing the composition into the cartons. Alternatively, this can be done if all liquid to be included, has already been included in the cheese-making factory, by sprinkling agar powder onto the pre-mix in the processing facility and mixing it into the pre-mix in a mixing tank.

As yet a further alternative, the premix can be prepared without the agar and the composition packed into cartons without including the agar. The agar can be supplied in a separate container, e.g. as powder in a sachet, such that each sachet provides a suitable amount of agar to be used with the premix of one carton.

1. A semi-finished food product that comprises
30-60 wt % soft fresh cheese,
15-50 wt % cream and/or milk, and
0.3-2 wt % polysaccharide gelling agent,
which food product is substantially free of egg yolk, gelatin and starch and which comprises
2.5-9 wt % milk protein
13-25 wt % fat
65-85 wt % water, and
0-5 wt % carbohydrate other than lactose.

2. A food product according to claim 1 that has a pH of 4.2-5.2

3. A food product according to claim 1 wherein the polysaccharide gelling agent is agar.

4. A food product according to claim 1 wherein the combined amount of fat and water is 80-96 wt %.

5. A food product according to claim 1 wherein the milk protein consists of 2-35 wt % whey protein and 65-98 wt % casein.

6. A food product according to claim 1 which comprises 3-7 wt % milk protein.

7. A food product according to claim 1 wherein the soft fresh cheese has a fat content of 18-40 wt %.

8. A food product according to claim 1 that is packed in two containers, wherein a first container contains a first part of a composition that constitutes the food product and a second container contains a second part of the composition that constitutes the food product, the second part being complementary to the first part.

9. A food product according to claim 8 wherein the first part comprises the gelling agent.

10. A food product according to claim 8 wherein the second part comprises the soft fresh cheese.

11. A food product according to claim 10 wherein the second part comprises cream.

12. A process for preparing a semi-finished food product according to claim 1 wherein in a cheese-making factory, soft fresh cheese, preferably in a pumpable condition, is mixed with at least part of the fluid ingredients to be included in the semi-finished food product thereby providing a composition that retains a pumpable consistency at 5° C. for a period of at least 24 hours.

13. A process according to claim 12 wherein the composition having a pumpable consistency is transferred in bulk to another location at which the composition is combined with the balance of the composition that is to constitute the semi-finished food product, and optionally, the semi-finished food product is packed in containers.
